(19) United States
(12) Patent Application Publication
(10) Pub. No.: US 2020/0104177 A1
(43) Pub. Date: Apr. 2, 2020

(54) RESOURCE ALLOCATION SYSTEM, MANAGEMENT DEVICE, METHOD, AND PROGRAM

(71) Applicant: NEC CORPORATION, Tokyo (JP)

(72) Inventor: Masaki INOKUCHI, Minato-ku, Tokyo (JP)

(73) Assignee: NEC CORPORATION, Tokyo (JP)

(21) Appl. No.: 16/616,525

(22) PCT Filed: May 30, 2017
(86) PCT No.: PCT/JP2017/020082

§ 371 Date: Nov. 25, 2019

(51) Int. Cl. G06F 9/50; G06F 16/28

(52) U.S. Cl. CPC G06F 9/5027; G06F 16/28

(57) ABSTRACT

A resource allocation system of the invention includes: a resource allocation unit 501 that allocates resources for executing services, allocating same to one or more functional units providing a predetermined function as a service; two or more resource provision units 502 that provide resources; a surplus resource amount acquisition unit 503 that acquires a surplus resource amount from a predetermined resource provision unit 502 among the two or more resource provision units 502; and a parameter determination unit 504 that, on the basis of the surplus resource amount, determines at least one among allocation timing, allocatable amount, and priority order at allocation, said allocation timing being timing at which resource allocation control is performed in the resource allocation unit 501 and said allocatable amount being a resource amount that can be allocated during one allocation control.

### TECHNICAL FIELD

The present invention relates to a resource allocation system, a management device, a method of allocating resources, and a resource allocation program, which allocate resources to one or more functional units. The functional units provide a predetermined function as a service.

### BACKGROUND ART

A service providing side demands to continuously provide service to legitimate users even when a failure occurs or a malicious device exists. A service providing base that satisfies such demand is desired.

One of service providing architectures includes a micro service architecture (hereinafter referred to as an MSA). The MSA finely divides a monolithic software architecture into a group of functional units with a low degree of coupling, and causes the functional units to cooperate with each other to provide equivalent service. The MSA can independently handle the function required to provide service, and thus has advantages of rapid development and deployment, excellent resiliency, and scalability.

FIG. 16 is an explanatory diagram showing an example of a service providing program using a microservice. FIG. 16 shows an example of an architecture in which a front-end service receives a service request from a user and causes a microservice in a subsequent stage to appropriately perform processing, and then a service is provided to the user by the processing cooperation. Examples of the microservice include authentication service, access permission, data management (update, deletion, and extraction), and recommendation. The MSA is used as an architecture for providing service on a cloud.

Resource management in a service system for providing service by causing such a plurality of functional units to cooperate with each other will be considered below. FIG. 17 is an explanatory diagram showing an example of a method of managing resources in the MSA. In the MSA, for example, a management entity monitors the usage status of resources in each microservice, and when, for example, the resource usage rate of a microservice exceeds a standard, the management entity newly allocates resources. When, for example, the resource usage rate of a microservice falls below the standard, the management entity releases resources. Here, the resource allocation may be to copy an instance of the corresponding microservice. The resource release may be to delete an instance of the corresponding microservice. The microservice itself may determine the resource usage status, and transmit a resource allocation request to the management entity.

Patent Literature 1 describes a method of performing resource distribution control with dynamic adaptability in accordance with the congested state of resources on the basis of requests of individual users (host computers) in a dispersive environment.

### CITATION LIST

### Patent Literature

PTL 1: Japanese Patent Application Laid-Open No. Hei 11-66018

### SUMMARY OF INVENTION

### Technical Problem

Unfortunately, resources cannot be appropriately allocated only by each resource server simply allocating resources on the basis of the remaining amount of the own resource with respect to resource usage status or a request of individual functional units, and imbalanced allocation occurs between the functional units. In particular, when allocation frequency and an allocation amount at one time, which will be referred to as allocation response speed below, are not appropriate, imbalance of resource allocation may occur between the functional units.

FIG. 18 is an explanatory diagram showing an example of the response speed for allocating resources in the MSA. FIG. 18 shows an example of resource allocation in a situation where resource allocation requests are generated in order from a front-end side along with, for example, an increase in the number of users in the case where the resources of the resource server are limited. Here, it is assumed that processing in the order of a front-end service X, a microservice A, a microservice B, and a microservice C is necessary in order to provide service requested by a user. At this time, when the number of users increases from the case where service is not in the congested state, the front-end service X first lacks resources, and performs a resource allocation request to a resource server. When the front-end service X reaches a state in which the front-end service X can process the request as a result of resource allocation, the microservice A to be called next is in the congested state, and lacks resource. The microservice A then performs a resource allocation request to the resource server.

At this time, if the resource server immediately allocates a request amount in response to the resource allocation request from individual functional units in a state of lacking resources, the resources are exhausted on the front-end side. Even if a resource allocation request arrives from the microservice B that is to be in a congested state next, there are no resources that can be allocated, and the resources cannot be allocated. As a result, resource imbalance occurs between the functional units. Since service to a user is not completed unless the processing of the microservice C is completed in the example, allocating many resources to the front-end side results in the failure of providing the service.

A possible method of inhibiting such lean of resources includes, for example, a resource server waiting for a fixed time without immediately allocating a request amount to a received request and determining, for example, an allocation amount and priority order on the basis of the request group accumulated during the time. Unfortunately, in the case of a service system, having high independence between functional units, such as the MSA, which service is to be congested next is often not sure until resources are actually allocated and service processing is performed. The above-described problems cannot be solved only by buffering a request. It is considered that the resource server immediately allocates only a part of the request amount first. In a system having low coupling degree among functional units, however, it is difficult for individual resource servers to determine how fast what amount should be allocated on the basis of only the currently recognized request.

In contrast, when the resource server has sufficient resources, it is demanded that resources of request amount should be immediately allocated to a functional unit that lacks resources. As described above, the appropriate response speed changes depending also on the resource usage status of the resource server.

In view of the above-described problems, an object of the invention is to provide a resource allocation system, a management device, a method of allocating resources, and a resource allocation program, which can inhibit resource allocation imbalance among one or more functional units, even when resources are allocated to the functional units, in a service system for providing service by causing the functional units to cooperate with each other.

### Solution to Problem

A resource allocation system of the invention includes: a resource allocation unit which allocates resources for executing services, allocating same to one or more functional units providing a predetermined function as a service; two or more resource provision units which provide resources; a surplus resource amount acquisition unit which acquires a surplus resource amount from a predetermined resource provision unit among the two or more resource provision units; and a parameter determination unit which, on the basis of the surplus resource amount, determines at least one among allocation timing, allocatable amount, and priority order at allocation, said allocation timing being timing at which resource allocation control is performed in the resource allocation unit and said allocatable amount being a resource amount that can be allocated during one allocation control.

A management device according to the invention is disposed in any one of a plurality of data centers, the data centers being provided as management units for resources provided by two or more resource provision units, the resource provision units providing resources to be allocated to one or more functional units providing a predetermined function as a service, and the management device includes: a resource allocation unit which allocates resources from the resources to be managed of an own data center to the one or more functional units; a surplus resource amount acquisition unit which acquires a surplus resource amount from a resource provision unit to be managed; an allocation status management unit which manages resource allocation status in the two or more resource provision units, the allocation status management unit managing the allocation status by sharing a blockchain, to which a block is added via predetermined consensus processing, with an allocation status management unit disposed in another data center, the block containing allocation information on allocation based on a resource allocation request to any one of the data centers, and a parameter determination unit which, on the basis of the surplus resource amount, determines at least one among allocation timing, allocatable amount, and priority order at allocation, said allocation timing being timing at which resource allocation control is performed in the resource allocation unit and said allocatable amount being a resource amount that can be allocated during one allocation control, in which the resource allocation unit allocates resources on the basis of information recorded in the blockchain as a result of the consensus processing performed on the basis of determination of the parameter determination unit.

In a method of allocating resources according to the invention, an information processing device: acquires a surplus resource amount from a predetermined resource provision unit among two or more resource provision units which provide resources to be allocated to one or more functional units, the one or more functional units providing a predetermined function as a service; and determines, on the basis of the surplus resource amount, at least one among allocation timing, allocatable amount, and priority order at allocation, said allocation timing being timing at which resource allocation control is performed in the resource allocation unit and said allocatable amount being a resource amount that can be allocated during one allocation control.

A resource allocation program according to the invention causes a computer to execute: processing of acquiring a surplus resource amount from a predetermined resource provision unit among two or more resource provision units which provide resources to be allocated to one or more functional units, the one or more functional units providing a predetermined function as a service; and processing of determining, on the basis of the surplus resource amount, at least one among allocation timing, allocatable amount, and priority order at allocation, said allocation timing being timing at which resource allocation control is performed in the resource allocation unit and said allocatable amount being a resource amount that can be allocated during one allocation control.

### Advantageous Effects of Invention

According to the invention, resource allocation imbalance among one or more functional units can be inhibited, even when resources are allocated to the functional units, in a service system for providing service by causing the functional units to cooperate with each other.

### BRIEF DESCRIPTION OF DRAWINGS

FIG. 1 is an explanatory diagram outlining a first exemplary embodiment.

FIG. 2 is a block diagram showing a configuration example of a resource allocation system 100 of the first exemplary embodiment.

FIG. 3 is a flowchart showing an operation example of the resource allocation system 100 of the first exemplary embodiment.

FIG. 4 is an explanatory diagram showing an example of the data structure of a blockchain.

FIG. 5 is a block diagram showing an example of a ledger management node 42 provided in a ledger management system 4.

FIG. 6 is an explanatory diagram outlining a second exemplary embodiment.

FIG. 7 is a block diagram showing a configuration example of a resource allocation system 100 of the second exemplary embodiment.

FIG. 8 is a flowchart showing an operation example of a DC 3 of the second exemplary embodiment.

FIG. 9 is an explanatory diagram showing an example of a method of selecting a request to be contained in a mining block.

FIG. 10 is an explanatory diagram showing another example of the method of selecting a request to be contained in a mining block.

FIG. 11 is an explanatory diagram showing an example of a method of determining a mining parameter.

FIG. 12 is an explanatory diagram showing an example of control of an allocatable amount.

FIG. 13 is a schematic block diagram showing a configuration example of a computer according to the exemplary embodiment of the invention.

FIG. 14 is a block diagram outlining a resource allocation system of the invention.

FIG. 15 is a block diagram showing another configuration example of the resource allocation system of the invention.

FIG. 16 is an explanatory diagram showing an example of a service providing program using a micro service.

FIG. 17 is an explanatory diagram showing an example of a method of managing resources in an MSA.

FIG. 18 is an explanatory diagram showing an example of response speed for allocating resources in the MSA.

### DESCRIPTION OF EMBODIMENTS

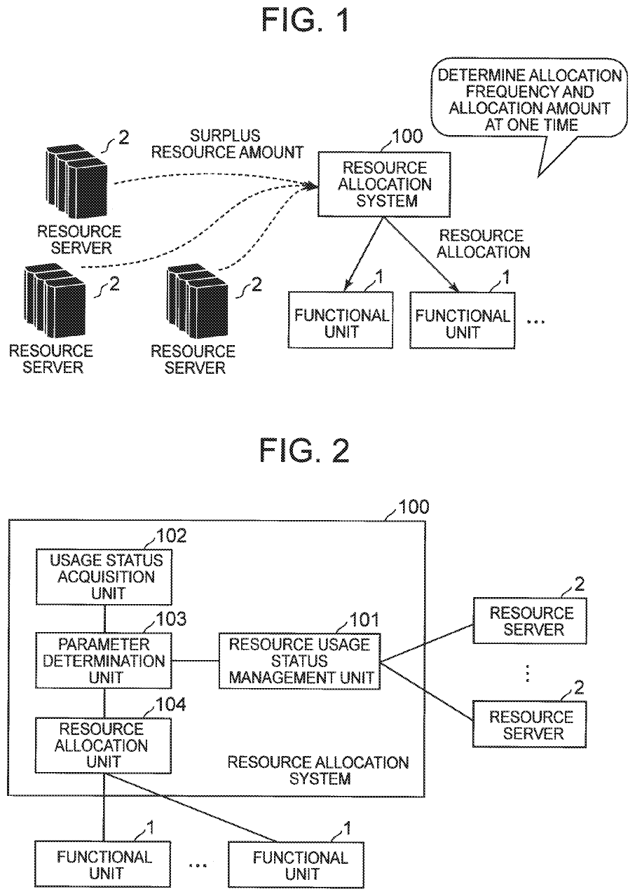

Exemplary embodiments of the invention will be described below with reference to the drawings. FIG. 1 is an explanatory diagram outlining a first exemplary embodiment. As shown in FIG. 1, a resource allocation system 100 of the exemplary embodiment collects a surplus resource amount from each of resource servers 2, and allocates resources to a functional unit 1 on the basis of the collected surplus resource amount. At the time, the resource allocation system 100 determines the response speed of resource allocation (specifically, e.g., allocation timing and an allocatable amount at one time) on the basis of the surplus resource amount, and allocates resources on the basis of the determination.

Here, the functional unit 1 is an independent unit that implements a predetermined function for providing service, such as the above-described microservice, and that provides the function in response to a request. Note that the functional unit 1 is not limited to an independent device, and may be a program that provides the function. That is, a plurality of functional units 1 may be implemented in one server or virtualization base. Even in such a case, each of the functional units 1 is regarded as an independent unit. In the invention, the function provided by the functional unit is also regarded as one service.

FIG. 2 is a block diagram showing a configuration example of the resource allocation system 100 of the exemplary embodiment. The resource allocation system 100 in FIG. 2 includes a resource usage status management unit 101, a usage status acquisition unit 102, a parameter determination unit 103, and a resource allocation unit 104.

The resource usage status management unit 101 manages (collects, holds) the usage status of resources in one or more resource servers 2 that manage resources to be allocated. Here, the usage status of resources managed by the resource usage status management unit 101 includes a surplus resource amount of each of the resource servers 2. Note that the past allocation status (e.g., to which functional unit 1 how many allocations have been made) may be also included.

The usage status acquisition unit 102 acquires the usage status of resources of each of the resource servers 2 from the resource usage status management unit 101. The acquisition timing is not particularly limited. For example, the acquisition may be performed at predetermined timing, such as at a fixed cycle, at when a resource allocation request is received, and after a fixed time has elapsed since reception of the resource allocation request.

The parameter determination unit 103 determines a resource allocation parameter on the basis of the usage status, acquired by the usage status acquisition unit 102, of resources of each of the resource servers 2. Here, the resource allocation parameter includes a resource allocation frequency and the allocatable amount at one time. Note that the resource allocation parameter may include either one. In that case, a predetermined value is used for the other. The allocation frequency is not particularly limited as long as the allocation frequency determines allocation timing that is timing for controlling allocation in the resource allocation unit 104. For example, the allocation frequency may be an allocatable number per unit time or an allocation interval. The resource allocation parameter may also include a rule (hereinafter referred to as an allocation order rule) regarding priority order for requests.

The resource allocation unit 104 allocates resources to the functional unit 1 on the basis of the resource allocation parameter determined by the parameter determination unit 103. For example, the resource allocation unit 104 allocates resources in response to a resource allocation request that has already been in a request buffer or that is to be received, at an allocation frequency indicated by the resource allocation parameter, and within a range of allocatable amount.

Note that, when a resource allocation request from a request source that has already been in the request buffer is received again, either of the received resource allocation request or the resource allocation request in the buffer may be canceled.

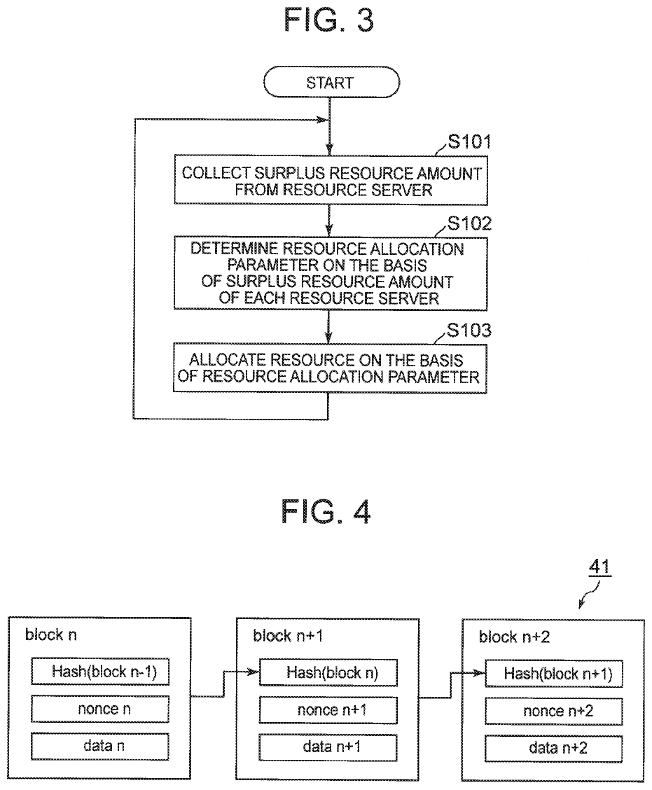

Operation of the exemplary embodiment will now be described. FIG. 3 is a flowchart showing an operation example of the resource allocation system 100 of the exemplary embodiment. In the example in FIG. 3, first, the resource usage status management unit 101 collects a surplus resource amount from each of the resource servers 2 as the usage status of resources (Step S101).

The parameter determination unit 103 determines a resource allocation parameter on the basis of the acquired surplus resource amount (Step S102).

The resource allocation unit 104 allocates resources to the functional unit 1 on the basis of the resource allocation parameter (Step S103).

In the case where the entire resource server is tight on resources, the parameter determination unit 103 may determine the resource allocation parameter on the basis of a resource-saving policy as follows in Step S102. For example, in the case where the entire resource server has spare resources, the parameter determination unit 103 may determine the resource allocation parameter on the basis of a high-performance policy as follows. Here, whether or not there is spare resources may be determined, for example, by determining whether or not the total surplus resource amount is equal to or greater than a predetermined threshold or has a proportion equal to or greater than a predetermined proportion to the entire resource amount.

[Resource-Saving Policy]
Lower allocation frequency Control example: cancel low-priority request Control example: give priority to request having small request amount
Reduce allocatable amount at one time

[High-Performance Policy]
Increase allocatable amount at one time
Increase allocation frequency or allow immediate allocation

Note that the resource allocation parameter may be set for the entire resource server or for each of the resource servers 2. In the latter case, the parameter determination unit 103 may determine the resource allocation parameter by, for example, selecting a policy in consideration of the proportion of the surplus resource amount of the resource server 2 of interest to the entire surplus resource amount.

In the case where a request has been already received and priority has been given to the request, the parameter determination unit 103 can also determine the resource allocation parameter on the basis of further the priority of the request. For example, the parameter determination unit 103 may perform allocation for a shorter time for a request having a higher priority. The parameter determination unit 103 can also first determine the allocation frequency, and then determine the allocatable amount at one time in response to expected time until resource allocation (required allocation time). That is, adjustments, such as increasing the allocatable amount at one time in the case where the required allocation time is long or reducing the allocatable amount at one time in the case where the required allocation time is short, may be performed.

The parameter determination unit 103 may also determine the allocation order rule on the basis of further past allocation status such that resources are allocated in priority to a functional unit having low allocation frequency in the past.

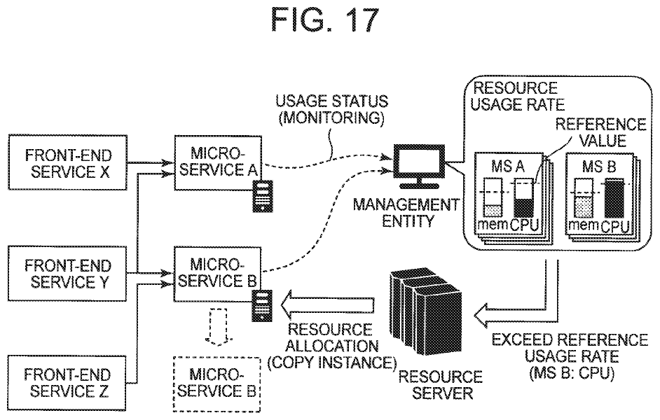

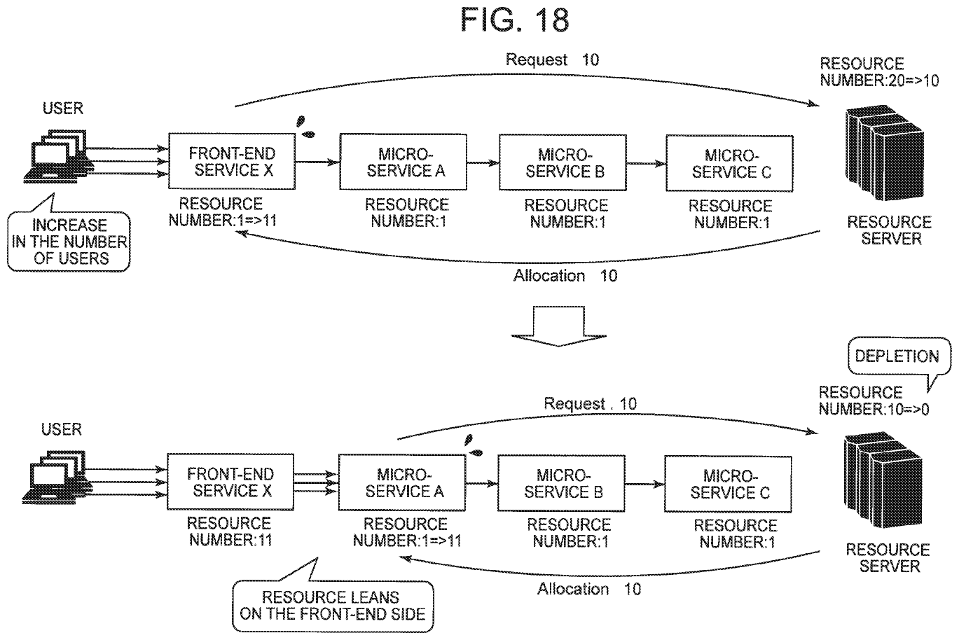

For example, the resource allocation system 100 of the exemplary embodiment can perform the above-described operation, not only in the case of being directly requested from the functional unit 1, but to a resource allocation request issued when a management entity as shown in FIG. 17 monitors resource usage status of the functional unit 1 and determines that a resource usage rate has exceeded a threshold. Note that the resource allocation system 100 can also monitor resources usage status from each functional unit and allocate resources as the management entity.

Even in such a case, the resource allocation system 100 allocates resources to the functional unit 1 whose resource usage rate has exceeded a threshold without exceeding the allocatable amount determined in accordance with the surplus resource amount acquired from the resource server 2. Note that the allocatable amount is decreased as the surplus resource is reduced. Note that the allocatable amount may be the number of instances that can be generated.

The resource allocation system 100 also allocates resources to the functional unit 1 whose resource usage rate has exceeded a threshold on the basis of an allocatable interval determined in accordance with the surplus resource amount acquired from the resource server 2. For example, when allocating resources, the resource allocation system 100 may suspend resource allocation until the allocatable interval elapses since the previous allocation.

In another method of controlling the allocation frequency, the resource allocation system 100 can provide probabilistic delay for the resource allocation request. That is, the resource allocation system 100 can determine a probability distribution (hereinafter, delay distribution), in which a certain determined value is defined as an average to the received resource allocation request, and set delay determined in accordance with the probability distribution for each resource allocation request. At this time, the resource allocation unit 104 allocates resources to the resource allocation request after set delay time has elapsed. In another method of providing probabilistic delay, the resource allocation system 100 can determine whether to probabilistically allocate resources at a fixed interval. In this case, the resource allocation unit 104 determines whether to allocate resources with a probability (hereinafter, resource allocation probability) determined for each resource allocation request to one or more resource allocation requests in the request buffer at a fixed interval. This can probabilistically provide the delay.

In the case where probabilistic delay is provided to the resource allocation request, the delay distribution or delay allocation probability can be determined for each resource allocation request, and can be determined on the basis of, for example, the past allocation status and the request level of the resource allocation request. The delay distribution or resource allocation probability determined for each of these resource allocation requests can be determined on the basis of a policy such as a resource-saving policy and a high-performance policy. For example, in the case of the resource-saving policy, the delay distribution having a large average value of delay may be set, and the resource allocation probability may be set small. In contrast, in the case of the high-performance policy, the delay distribution having a small average value of delay may be set, and the resource allocation probability may be set large.

As described above, according to the exemplary embodiment, even when resources are allocated to a service system with opaque relation between functional units, response speed of resource allocation can be appropriately set in accordance with a surplus resource amount and a past allocation status. This makes it possible to inhibit resource allocation imbalance among functional units. Examples of the resource allocation imbalance include depletion of resources before a functional unit of subsequent stage is congested with services due to lean of the resources on the front-end-service side.

### Second Exemplary Embodiment

A second exemplary embodiment of the invention will now be described. In the exemplary embodiment, for example, even if a network between a plurality of geographically scattered data centers (DCs) serving as resource management units is disrupted, service can be continued by using another DC. In the exemplary embodiment, resources can be allocated across a plurality of data centers. No centralized management entity is placed so that service can be continued even if the network between the data centers is disrupted.

More specifically, in the resource allocation system of the exemplary embodiment, information on allocation based on a request and a past allocation status are shared between the data centers by using a system for dispersively gaining a consensus in a dispersion ledger system that uses blockchain technology and using a shared information holding mechanism in the system.

The blockchain technology will first be briefly described. The blockchain technology is an architecture in which information can be dispersively shared without depending on a specific centralized management server. A blockchain difficult to falsify is shared between terminals by each terminal (later-described ledger management node 42) that participates in a dispersion ledger system performing processing (hereinafter referred to as consensus processing) that depends on predetermined consensus algorithm at the time of adding a block to a blockchain.

FIG. 4 is an explanatory diagram showing an example of the data structure of a blockchain 41. As shown in FIG. 4, the blockchain 41 has a configuration of connection of data having predetermined data structure called a block. Each of the blocks contains a hash value (“Hash x” in the figure) of the previous block, nonce (“nonce x” in the figure), and data (“data x” in the figure) stored in the block. Here, “x” represents an identifier for identifying a block. For example, a block n includes the hash value of a block n−1, nonce n, and data n. Note that any data such as transaction information may be the data n.

The blockchain 41 that is difficult to falsify can be used for, for example, verifying information as a ledger by causing the blockchain 41 to hold data on, for example, transaction details, application information, and other pieces of information such as management information and authentication information.

Here, nonce is verification information that influences the falsification resistance of the blockchain 41. Specifically, the nonce plays a role as verification information set in the process of executing consensus algorithm called proof of work (PoW).

In PoW, processing (hereinafter simply referred to as processing of searching for nonce) of searching for a value to be set in a nonce region contained in certain data is performed on the data so that a value obtained when the data is processed by a unidirectional function satisfies a predetermined rule.

At this time, for example, a hash function can be used as the unidirectional function. The rule at that time can be set as “a hash value is equal to or less than a threshold (target value)”. Generally, the processing of searching for nonce cannot be efficiently performed due to the nature of unidirectional function. For this reason, a device for performing the processing actually repeats operation of setting an appropriate value for nonce and checking whether the rule is satisfied. Many nodes perform such an operation of setting and checking in parallel. The node that finds nonce satisfying the rule fastest transmits information to other nodes. All nodes then confirm the state of data containing a value of the nonce (consensus is gained) on the basis of the information.

A general flow of adding a block in the blockchain 41 will now be described. A block is added to the blockchain 41 by operations such as the following (1) to (5).
(1) A terminal that desires to record information in the blockchain 41 notifies any or all of terminals participating in the blockchain 41 of the information.
(2) Each terminal checks the consistency of the received information, and if there is no problem, generates a block.
(3) Each terminal starts PoW for the generated block.
(4) A terminal that has finished PoW notifies all terminals of the block in which the nonce found in the PoW is set.
(5) A terminal that has been notified of the block in which the nonce is set checks a hash value and the consistency of the information stored in the block, and if there is no problem, adds the block to the tail end of the blockchain 41 managed by the terminal itself.

Note that, in the above-described operation of (2), the method of checking the consistency of the received information depends on an application that uses the blockchain 41. When a block is generated, a plurality of pieces of information can be combined into one block.

In the above-described PoW operation of (3), each terminal further performs the following operations.

(3-1) Each terminal first sets a random nonce (nonce candidate) to the generated block.

(3-2) Each terminal checks whether the hash value of the block satisfies a predetermined rule (e.g., whether the hash value of the block is equal to or less than a certain target value).

(3-3) When the rule is satisfied, each terminal finishes the processing. When the rule is not satisfied, each terminal changes the set nonce and returns to (3-2).

Note that all terminals that have been notified of the information simultaneously perform the above-described PoW operation of (3) in parallel. The terminal that has finished PoW fastest is regarded as a terminal that has gained a right to add a block to the blockchain 41.

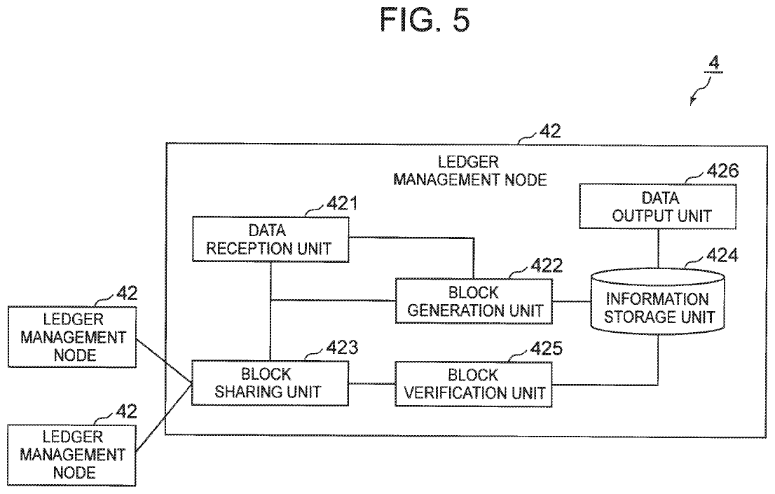

FIG. 5 is a block diagram showing an example of the ledger management node 42 provided in a ledger management system 4. The ledger management system 4 includes two or more ledger management nodes 42 (not shown). When a new block is added to a blockchain, each ledger management node performs predetermined consensus processing, and holds a copy of the blockchain 41. Note that consensus algorithm in the ledger management system 4 is not limited to PoW. For example, consensus algorithm such as byzantine fault tolerance (BFT) can also be used in addition to PoW.

The ledger management node 42 in FIG. 5 includes a data reception unit 421, a block generation unit 422, a block sharing unit 423, an information storage unit 424, a block verification unit 425, and a data output unit 426.

The data reception unit 421 receives information to be recorded in the blockchain 41 from an external node. In the exemplary embodiment, the data reception unit 421 receives, for example, allocation information based on a later-described resource allocation request (transaction) serving as information to be recorded in the blockchain 41.

The block generation unit 422 generates a block to be added to the blockchain by using the information received by the data reception unit 421. The block generation unit 422 generates a block including information (e.g., hash value) based on the previous block and information received by the data reception unit 421. The block generation unit 422 performs, for example, processing of searching for a nonce or processing of giving a signature on the block generated by the block generation unit 422 itself or the block generated by another ledger management node 42 via the later-described block sharing unit 423 as predetermined consensus processing, and adds the block to a blockchain (corresponding to a copy of the blockchain 41) managed by the block generation unit 422 itself. A block obtained by a plurality of ledger management node 42 performing predetermined consensus processing on the block generated by the block generation unit 422 is finally added to the blockchain 41. Processing, which includes consensus processing, for adding a block to a blockchain may be referred to as mining below. A node that performs mining may be referred to as a miner.

The block sharing unit 423 exchanges information between the ledger management nodes 42 belonging to the ledger management system 4. More specifically, the block sharing unit 423 appropriately transmits, for example, information received by the data reception unit 421, a block generated by the block generation unit 422, and a block received from another ledger management node 42 to another ledger management node 42. As a result, all possible ledger management nodes 42 share these pieces of information and the latest blockchain 41.

The information storage unit 424 stores a copy of the blockchain 41. Note that the information storage unit 424 may store, for example, information necessary for verification processing at the later-described block verification unit 425 in addition to the copy of the blockchain 41.

The block verification unit 425 verifies a block when adding the block to the blockchain held by the block verification unit 425 itself. For example, the block verification unit 425 may verify whether a block to be added actually satisfies a rule, whether a node that has generated the block and a signature are matched, and whether information, based on the previous block, in the block to be added matches information generated from the actual previous block.

The data output unit 426 searches for and outputs a block containing desired information from the blockchain 41 held by the data output unit 426 itself in response to a request from an external node.

Note that the configuration in FIG. 5 is merely one example, and the ledger management node 42 can perform predetermined consensus processing for a plurality of nodes to share and manage the blockchain 41 having the above-described characteristics. Any specific configuration is possible as long as a node can add information to a ledger in response to a request from an external node and can refer to a ledger.

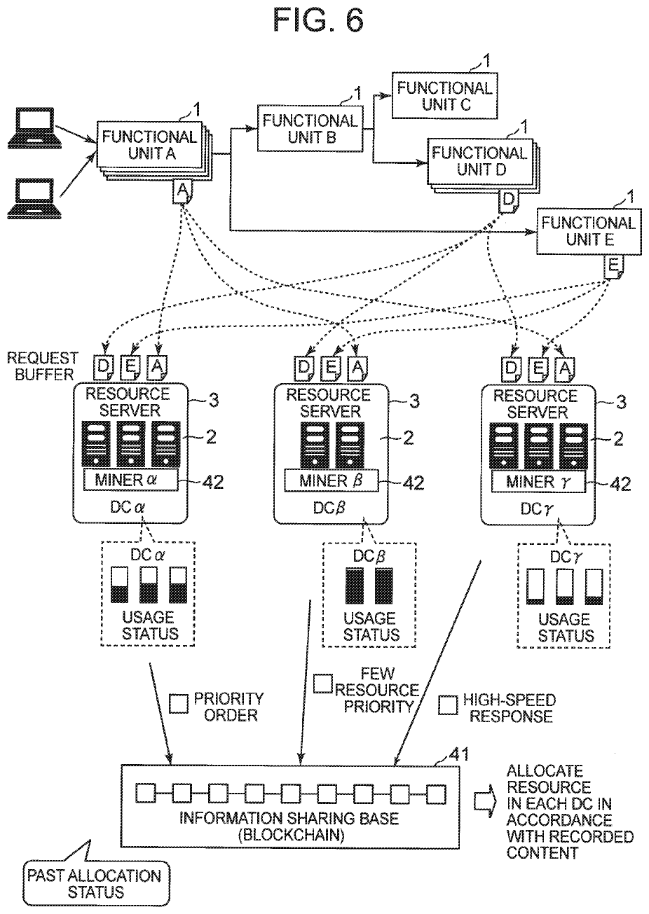

A method of using a blockchain in the exemplary embodiment will now be described. FIG. 6 is an explanatory diagram outlining the exemplary embodiment. As shown in FIG. 6, in the exemplary embodiment, a data center (DC) 3, which is a resource management unit, is provided with a miner (ledger management node 42), which is a PoW execution node. Each DC 3 locally collects resource allocation status and a surplus resource amount from the blockchain 41 held by the DC 3 itself and the resource server 2 managed by the DC 3 itself, and determines a resource allocation policy (e.g., response time and to which functional unit resources are allocated) in the DC 3. Each DC 3 generates a block containing, for example, a request to be processed and allocation content based on the request, and dispersively gains consensus for the block by using PoW in accordance with the determined resource allocation policy. Note that, in the exemplary embodiment, the functional unit 1 and a monitoring entity 1A transmits resource allocation requests to all resource servers 2 that desire resource allocation.

This causes a policy supported by more miners to be easily selected at the time of allocating resources in each DC. This is because, for example, a resource allocation policy determined by two miners is reflected to a total of two blocks generated by each of the miners and used for consensus processing, so that computation amount for mining is doubled compared to a policy supported by one miner.

Each DC can control an allocatable amount in one allocation control by changing the content and number of a transaction (request) in the block in accordance with the policy. In addition, each DC can control allocation timing by changing a parameter (particularly, parameter regarding a difficulty level of consensus processing) at the time of mining.

FIG. 6 shows an example in which functional units A, D, and E transmit resource allocation requests to DCs α, β, and γ, respectively. It is assumed that the resource server 2 managed by the DC α is in the resource usage status of “normal state (state where these is spare as usual)”. In contrast, it is assumed that the resource server 2 managed by the DC β is in the resource usage status of “tight state (state where these is no spare)”. In addition, it is assumed that the resource server 2 managed by the DC γ is in the resource usage status of “idle state (state where there is large spare)”.

In such a case, the DC α determines a resource allocation policy of, for example, “priority order” on the basis of information held by the DC α itself. In such a case, the DC β determines a resource allocation policy of, for example, “few resource priority” on the basis of information held by the DC β itself. The DC γ determines a resource allocation policy of, for example, “high-speed response” on the basis of information held by the DC γ itself. Here, the “priority order” is a policy of preferentially allocating resources to a request having a high priority within a range in which a DC can allocate the resource. The “few resource priority” is a policy of preferentially allocating resources to a request having a few request amount within the range in which the DC can allocate the resource. The “high-speed response” is a policy of immediately allocating resources in a reception order within the range in which the DC can allocate the resource.

In this way, even in the state of receiving the same request, a policy to be determined in accordance with the resource usage status of the DC itself is determined for each DC. A block, whose selected request and number may be different, is generated on the basis of the policy determined in such a way, and used for the consensus processing in each DC. As a result, the block for which consensus can be gained fastest is added to the blockchain 41, and shared between the DCs. When the block is added to the blockchain 41, each DC allocates resources in accordance with information in the added block. For example, each DC may cause the block to contain an identifier given to each request, and clarify which request has been registered in the blockchain.

Repeating such operation causes the blockchain 41 to hold the past allocation status in the entire system. Consequently, each DC can acquire not only the latest usage status in the resource server 2 managed by the DC itself but the past allocation status in the entire system including another DC 3 without inquiring of the other DC 3 each time.

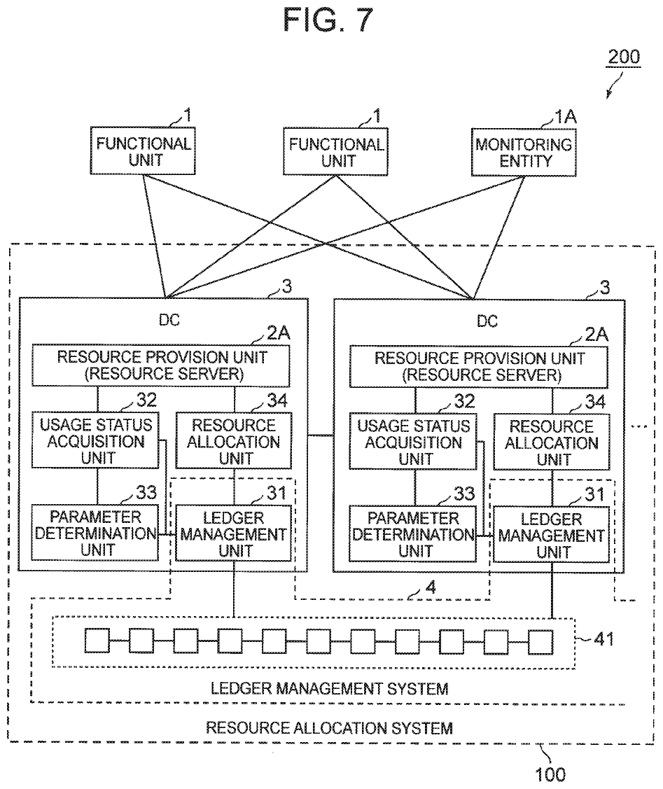

FIG. 7 is a block diagram showing a configuration example of the resource allocation system of the second exemplary embodiment. The resource allocation system 100 of the exemplary embodiment operates as a resource allocation system that allocates resources held by a resource provision unit 2A to the functional unit 1 in a service system 200. The service system 200 includes, for example, one or more functional units 1 and the monitoring entity 1A that monitors the functional units 1.

The resource allocation system 100 in FIG. 7 includes one or more data centers (DCs) 3. Note that the DCs 3 are connected to each other via a network.

Each of the DCs 3 includes the resource provision unit 2A, a ledger management unit 31, a usage status acquisition unit 32, a parameter determination unit 33, and a resource allocation unit 34. Note that the DC 3 is an optional resource management unit, and the geographical and physical configurations are not particularly limited. Although, one resource provision unit 2A is allocated to one DC 3 in FIG. 7, any one or more resource provision units 2A of two or more resource provision units 2A provided in the service system 200 are only required to be allocated, and the number of the resource provision units 2A is not particularly limited.

In the example, the ledger management unit 31 in each DC operates as the above-described miner. A node that transmits a resource allocation request of, for example, the functional unit 1 and the monitoring entity 1A operates as an entity that uses the blockchain 41. Typically, each entity has a pair of a secret key and a public key, adds a signature to transaction with the secret key, and transmits the transaction to the miner (in the example, the ledger management unit 31 in the own DC). The miner generates a block on the basis of the transmitted transaction, and adds the block to the blockchain through consensus processing. Each entity can acquire miner information from other entities when participating in the system.

Although FIG. 7 shows one blockchain 41, the blockchain 41 is actually held in each of the ledger management units 31 serving as the ledger management nodes 42 in the ledger management system 4.

In the example, the resource provision unit 2A, the ledger management unit 31, the usage status acquisition unit 32, the parameter determination unit 33, and the resource allocation unit 34 correspond to the resource server 2, the resource usage status management unit 101, the usage status acquisition unit 102, the parameter determination unit 103, and the resource allocation unit 104 in the first exemplary embodiment, respectively. In the exemplary embodiment, the ledger management unit 31 further has a part of the function of the parameter determination unit 103.

The resource provision unit 2A manages resources that can be allocated at the DC.

The ledger management unit 31 includes, for example, each component of the ledger management node 42 in FIG. 5. In the exemplary embodiment, when a request (transaction) to be contained in the block and a mining parameter are specified by the later-described parameter determination unit 33, the ledger management unit 31 generates a block containing the transaction, and performs mining in accordance with the specified parameter. When the mining is successful, the ledger management unit 31 adds the block to the blockchain 41 of the ledger management unit 31 itself, and performs sharing processing with other ledger management units 31 (transmits a block for which mining has been successful). When a new block is added to the blockchain 41 managed by the ledger management unit 31 itself, the ledger management unit 31 may notify the parameter determination unit 33 or the resource allocation unit 34 of the addition.

The usage status acquisition unit 32 acquires resource usage status in the own DC and past resource allocation status in each DC from the resource provision unit 2A and the blockchain 41 (more specifically, copy of the blockchain 41 held in the information storage unit 424 of the ledger management unit 31) at predetermined timing. The predetermined timing is not particularly limited. Examples of the predetermined timing include timing at a fixed cycle, timing when a resource allocation request is received, and timing after a fixed time has elapsed since reception of the resource allocation request.

The parameter determination unit 33 determines a method of selecting a request to be contained in a mining block and a mining parameter on the basis of the information acquired by the usage status acquisition unit 32. Here, the mining block is a block that is targeted for mining by the miner. The method of selecting a request to be contained in the mining block is a method of selecting a request subject to the next allocation processing, and defines on the basis of what how many requests are selected. The mining parameter is only required to be a parameter regarding the difficulty level of consensus processing, such as a parameter that determines time required for mining. For example, the mining parameter is a target value of PoW.

For example, the parameter determination unit 33 may determine a method of selecting a request and a mining parameter by selecting one policy from resource allocation policies in which a combination of the method of selecting a request and the mining parameter is preliminarily set.

When the method of selecting a request and the mining parameter are determined, the parameter determination unit 33 notifies the ledger management unit 31 of a block addition request together with the mining parameter. In the block addition request, the determined selection method or a request (transaction) selected in accordance with the selection method is specified. At this time, the parameter determination unit 33 can change the selected request to a request amount different from that received at the DC.

When a block is added to the blockchain 41 managed by the ledger management unit 31, the resource allocation unit 34 allocates resources on the basis of the transaction in the block. For example, the resource allocation unit 34 may allocate resources to the transaction in the block within the range in which the resource allocation unit 34 can allocate the resource.

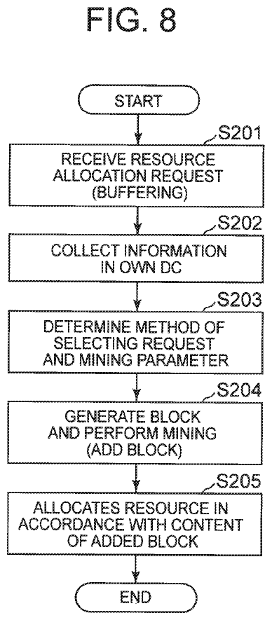

Operation of the exemplary embodiment will now be described. FIG. 8 is a flowchart showing an operation example of the DC 3 in the resource allocation system 100 of the exemplary embodiment.

In the example in FIG. 8, each DC 3 first receives a resource allocation request (Step S201). The resource allocation request received here is sequentially buffered. The transmission source of the resource allocation request is not particularly limited. For example, the transmission source may be the functional unit 1 or the monitoring entity 1A.

The usage status acquisition unit 32 acquires the resource usage status in the own DC and the past resource allocation status in each DC from the information held by the own DC (Step S202). In Step S202, the usage status acquisition unit 32 acquires, for example, the resource usage status in the own DC and the past resource allocation status in each DC.

The parameter determination unit 33 determines a method of selecting a request to be contained in a mining block and a mining parameter on the basis of the acquired information (Step S203).

The ledger management unit 31 generates the mining block containing the request selected from the received requests in accordance with the determined selection method, and performs mining on the mining block in accordance with the determined mining parameter (Step S204). Here, the mining block contains resource allocation information (information indicating to which functional unit how many resources are to be allocated) based on a resource allocation request.

Note that the operation of Step S204 is simultaneously performed in parallel at each DC. In general, the block that has succeeded in mining fastest is added to the blockchain 41 of each DC by sharing processing. Note that the ledger management unit 31 of each DC can also refuse to add a block as a result of verification.

When a new block is added to the blockchain 41, the resource allocation unit 34 allocates resources on the basis of the information in the block (Step S205).

Each DC proceeds to the next allocation control (returns to Step S202), for example, each time a block is added and one allocation control is finished. In each allocation control, the operations of Step S202 to Step S205 are required to be performed for requests that have arrived so far.

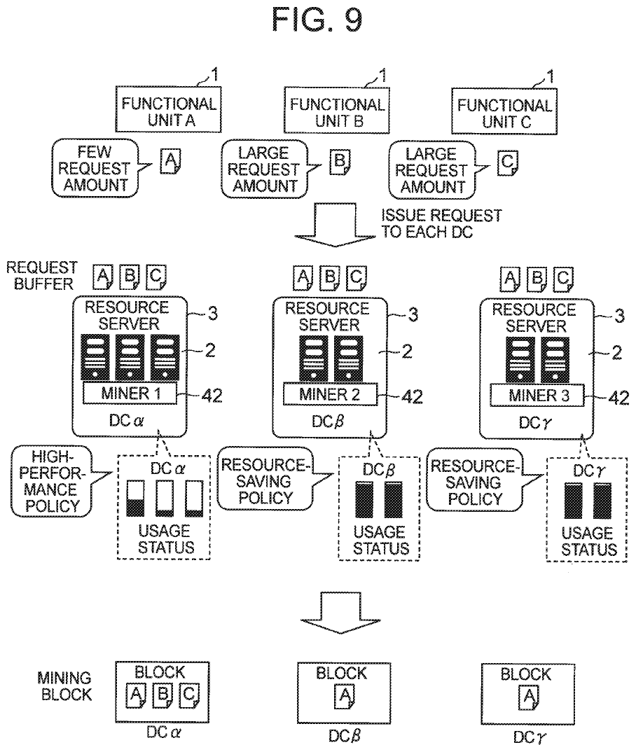

FIG. 9 is an explanatory diagram showing an example of a method of selecting a request to be contained in a mining block. In the example in FIG. 9, the resource provision unit 2A managed by the DC α is in the resource usage status of “idle state”. The resource provision units 2A managed by the DCs β and γ are in the resource usage status of “tight state”. A resource allocation request (“transaction A”) from the functional unit A, a resource allocation request (“transaction B”) from a functional unit B, and a resource allocation request (“transaction C”) from a functional unit C are stored in this order in a request buffer of each DC. The request amount of the “transaction A” is smaller than the request amounts of the “transaction B” and the “transaction C”.

In such a case, the parameter determination unit 33 of the DC α may select the above-described “high-performance policy” as a resource allocation policy. The “High-performance policy” is a policy of allocating many resources in one control. When the policy is selected, for example, all the requests stored in the request buffer are selected. The parameter determination units 33 of the DCs β and γ may select the above-described “resource-saving policy” as the resource allocation policy. The “resource-saving policy” is a policy of reducing the amount of resources to be allocated in one control by canceling a low-priority request or giving priority to a request having a low request amount. When the policy is selected, for example, the predetermined number of requests are selected from the requests stored in the request buffer on the basis of the priority of the request and the request amount. At this time, the remaining requests that have not been selected remain stored in the request buffer. The remaining requests can be canceled after a certain time has elapsed since reception of the request.

Note that FIG. 9 shows an example in which a block containing the “transaction A”, the “transaction B”, and the “transaction C” is generated as a mining block of the DC α. In the shown example, blocks containing the “transaction A” are generated as mining blocks of the DCs β and γ.

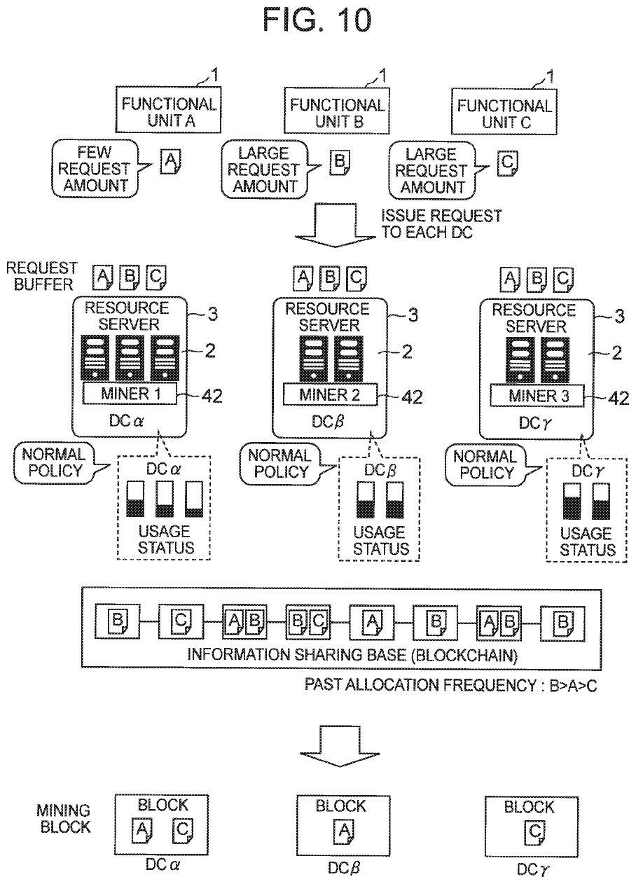

FIG. 10 is an explanatory diagram showing another example of a method of selecting a request to be contained in the mining block. In the example in FIG. 10, the resource provision units 2A managed by the DCs α, β, and γ are all in the resource usage status of “normal state”. The request buffer of each DC in the example is in the state similar to that in FIG. 9. In the example, the relation of allocation frequency between the functional units 1, that is, the functional unit B>the functional unit A>the functional unit C is grasped from the past allocation status, indicated by the blockchain 41, in each DC.

In such a case, the parameter determination unit 33 of each DC may select a “frequency priority policy”. The “frequency priority policy” is, for example, a policy of causing a block to contain the predetermined number of requests, and at the time, causing a block to contain a request from a functional unit having lower allocation frequency with a higher probability. Note that the policy may be selected independently of other policies, or may be selected in combination with other policies. The “frequency priority policy” can be used, for example, to determine the priority order for the number of requests selected by another policy.

For example, the parameter determination unit 33 may determine the final method of selecting a request on the basis of results of control based on the resource usage status in the own DC and control based on the past allocation status in each DC.

A method of determining a mining parameter will now be described. The parameter determination unit 33 may determine the target value of PoW, for example, in accordance with the surplus resource amount of the resource provision unit 2A to be managed. In one example, the more the resource remains, the higher the target value may be set (the more the mining may be simplified). Simplifying the mining enables fast response speed.

The parameter determination unit 33 may determine the target value of PoW, for example, in accordance with the request in the mining block. In one example, the higher priority the request group in the block has, the higher the target value may be set (the more the mining may be simplified). In relation to the operation, the parameter determination unit 33 may reconfigure the mining block when the own DC newly receives a request having a high priority during mining of the mining block in the ledger management unit 31. In that case, the parameter determination unit 33 causes the ledger management unit 31 to cancel the current mining, notifies the ledger management unit 31 of the reconfigured mining block, and causes the ledger management unit 31 to performs mining again.

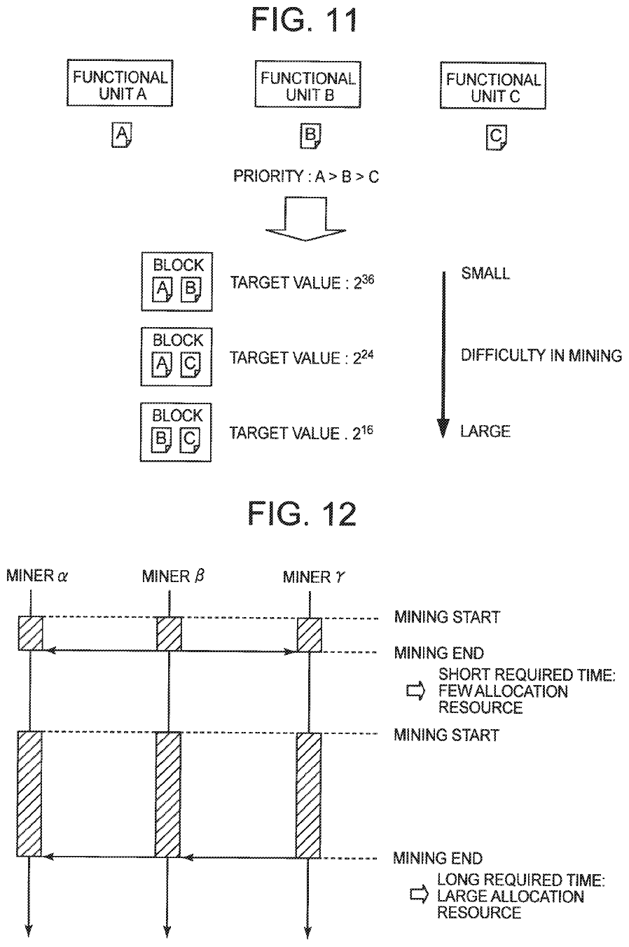

Such control based on the priority of a request can inhibit excessive allocation of resources to a request having a low priority. FIG. 11 is an explanatory diagram showing an example of a method of determining a mining parameter. In the example in FIG. 11, a target value is set on the basis of a priority.

FIG. 12 is an explanatory diagram showing an example of control of an allocatable amount. Each miner (more specifically, the ledger management unit 31, the parameter determination unit 33, and the resource allocation unit 34) may change the allocatable amount in accordance with the time required for mining of a block to be controlled. Here, the time required for mining may be an estimated time, a time that has been actually required, or a time elapsed from the actual addition of the previous block to the addition of the block. In one example, the shorter the required time is, the less the allocatable amount may be set, and the longer the required time is, the more the allocatable amount may be set.

In the exemplary embodiment, for example, a management device serving as a miner in each DC selects a request to be contained in the mining block and sets the mining parameter on the basis of the information in the own DC. The miner in each DC performs mining on different mining blocks generated by different policies with mining parameters set by the different policies. As a result of mining of each miner, consensus is gained, and a block is added to the blockchain at each DC. When the block is added, each DC allocates resources in accordance with information recorded in the added block.

Note that each DC may record not a request (transaction) to be processed but a resource allocation policy itself in the block. In that case, each DC allocates resources in accordance with the resource allocation policy recorded in the block at the timing when a new block is added to the blockchain 41 of each DC. In this case, the block addition timing is defined as update timing of the resource allocation policy. Such a request, an identifier of the request, allocation content determined on the basis of the selected request, and a resource allocation policy, which are given as examples of information to be contained in the block, may be collectively referred to as “allocation information on allocation based on a resource allocation request”.

In the exemplary embodiment, the response speed of resource allocation is adjusted by using the consensus processing based on PoW of a dispersion ledger system. As a result, resource allocation balanced in the entire system can be achieved while maintaining the independence of each entity. For example, in the example in FIG. 9, even when only a specific DC has spare resource, the resource-saving policy is easily adopted, and depletion and lean of resources due to biased request and information collection can be inhibited.

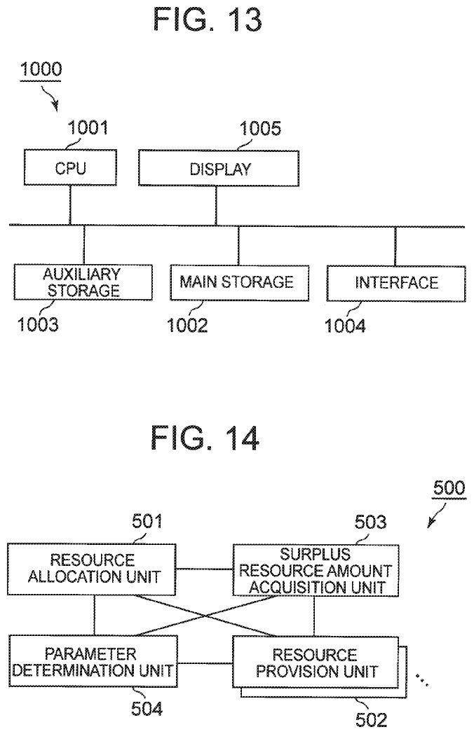

A configuration example of a computer according to the exemplary embodiment of the invention will now be described. FIG. 13 is a schematic block diagram showing the configuration example of a computer according to the exemplary embodiment of the invention. A computer 1000 includes a CPU 1001, a main storage 1002, an auxiliary storage 1003, an interface 1004, a display 1005, and an input device 1006.

For example, the above-described functional unit 1, each component in the DC 3, and the ledger management node 42 may be implemented in the computer 1000. In that case, the operation of each device (device implemented with the functional unit, the component, and a node) may be stored in the auxiliary storage 1003 in the form of a program. The CPU 1001 reads the program from the auxiliary storage 1003, decompresses the program in the main storage 1002, and performs predetermined processing in the above-described exemplary embodiment in accordance with the program.

The auxiliary storage 1003 is an example of a non-transitory tangible media. Other examples of the non-transitory tangible media include magnetic disks, magneto-optical disks, CD-ROMs, DVD-ROMs, and semiconductor memories, which are connected via the interface 1004. When the program is delivered to the computer 1000 over a communication line, the computer 1000, which received the delivery, may decompress the program in the main storage 1002 and perform predetermined processing in the above-described exemplary embodiment.

The program may be used for performing a part of predetermined processing in each exemplary embodiment. The program may be a difference program for performing the predetermined processing in the above-described exemplary embodiment in combination with another program already stored in the auxiliary storage 1003.

The interface 1004 transmits and receives information to and from another device. The display 1005 presents information to a user. The input device 1006 receives input of information from the user.

Some elements of the computer 1000 can be omitted depending on the processing content in the exemplary embodiment. For example, when a device does not present information to the user, the display 1005 can be omitted.

Part or all of each component of each device is implemented by, for example, a general-purpose or dedicated circuitry, a processor, or a combination thereof. These may be configured by a single chip, or may be configured by a plurality of chips connected via a bus. Part or all of each component of each device may be implemented in combination of, for example, the above-described circuitry and a program.

When the part or all of each component of each device is implemented by, for example, a plurality of information processing device and circuitry, the plurality of information processing device and circuitry may be disposed centrally or dispersively. For example, the information processing device, circuitry, and the like may be implemented in a form in which, for example, a client-and-server system and a cloud computing system, each component are connected via a communication network.

A resource management system of the invention will now be outlined. FIG. 14 is a block diagram outlining a resource allocation system of the invention. A resource allocation system 500 in FIG. 14 includes a resource allocation unit 501, two or more resource provision units 502, a surplus resource amount acquisition unit 503, and a parameter determination unit 504.

The resource allocation unit 501 (e.g., the resource allocation unit 104 and the resource allocation unit 34) allocates resources for executing services, allocating same to one or more functional units providing a predetermined function as a service.

The resource provision unit 502 (e.g., the resource server 2 and the resource provision unit 2A) provides resources.

The surplus resource amount acquisition unit 503 (e.g., the usage status acquisition unit 102 and the usage status acquisition unit 32) acquires a surplus resource amount from a predetermined resource provision unit among the two or more resource provision units.

The parameter determination unit 504 (e.g., the parameter determination unit 103 and the parameter determination unit 33), on the basis of the surplus resource amount, determines at least one among allocation timing, allocatable amount, and priority order at allocation. The allocation timing is timing at which resource allocation control is performed in the resource allocation unit. The allocatable amount is a resource amount that can be allocated during one allocation control.

Such configuration enables resource allocation at an appropriate response speed even when resources are allocated to a service system with opaque relation between functional units, and thus imbalance of resource allocation between functional units can be inhibited.

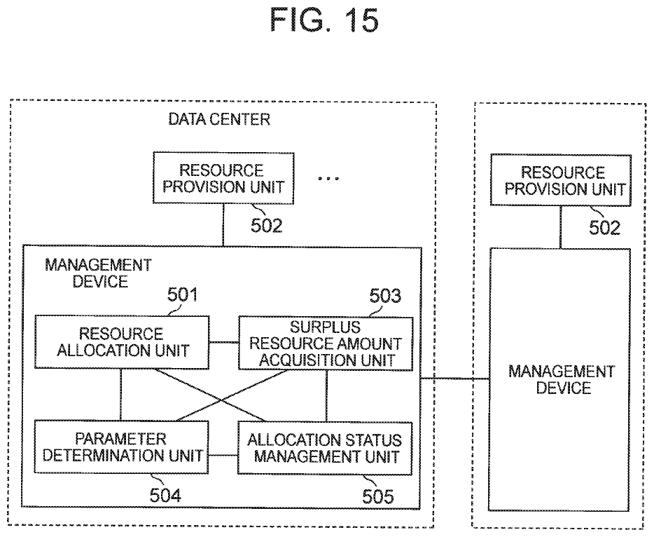

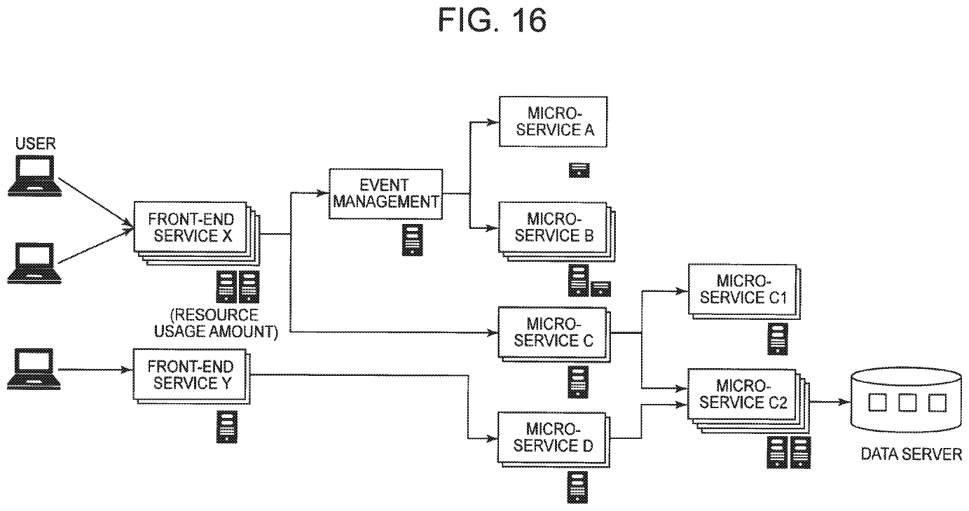

FIG. 15 is a block diagram showing another configuration example of a resource allocation system of the invention. For example, the resource allocation system 500 of the invention may be configured as shown in FIG. 15.

That is, the resource allocation system 500 may further include an allocation status management unit 505 and a plurality of data centers. The allocation status management unit 505 manages resource allocation status in the two or more resource provision units 502. The plurality of data centers serves as management units for resources provided by two or more resource provision units 502. The resource allocation system 500 may include a management device disposed in any one of these data centers. Each management device may include the resource allocation unit 501, the surplus resource amount acquisition unit 503, the parameter determination unit 504, and the allocation status management unit 505.

In such configuration, the resource allocation unit 501 allocates resources from resources to be managed of the own data center to a functional unit.

The surplus resource amount acquisition unit 503 acquires a surplus resource amount from a resource provision unit that provides resources to be managed.

The parameter determination unit 504 determines at least one of the allocation timing, the allocatable amount, and the priority order at the time of allocation on the basis of the surplus resource amount. The allocation timing is timing at which resource allocation control is performed in the resource allocation unit. The allocatable amount is a resource amount that can be allocated during one allocation control.

The allocation status management unit 505 (e.g., the resource usage status management unit 101 and the ledger management unit 31) manages allocation status by sharing a blockchain, to which a block is added, with the allocation status management unit 505 (not shown) disposed in another data center. The block contains, through predetermined consensus processing, allocation information on allocation based on a resource allocation request to any one of the data centers. The resource allocation unit 501 allocates resources on the basis of information recorded in the blockchain as a result of the consensus processing performed on the basis of determination of the parameter determination unit 504.

According to such a configuration, resources can be allocated at an appropriate response speed only with information in a data center by using a system for dispersively gaining consensus in a ledger management system and a shared information holding mechanism in the system, so that imbalance of resource allocation between functional units can be inhibited.

Although the invention has been described above with reference to the exemplary embodiments and the examples, the invention is not limited to the above-described exemplary embodiments and examples. Various modification that can be understood by those skilled in the art can be added to the configuration and details of the invention within the scope of the invention.

### INDUSTRIAL APPLICABILITY

The invention can be preferably applied to an application for resiliently providing service.

### REFERENCE SIGNS LIST

100 Resource allocation system
101 Resource usage status management unit
102 Usage status acquisition unit
103 Parameter determination unit
104 Resource allocation unit
200 Service system
1 Functional unit
1A Monitoring entity
2 Resource server
2A Resource provision unit
3 DC
31 Ledger management unit
32 Usage status acquisition unit
33 Parameter determination unit
34 Resource allocation unit
4 Ledger management system
41 Blockchain
42 Ledger management node
421 Data reception unit
422 Block generation unit
423 Block sharing unit
424 Information storage unit
425 Block verification unit
426 Data output unit
1000 Computer
1001 CPU
1002 Main storage
1003 Auxiliary storage
1004 Interface
1005 Display
1006 Input device
500 Resource allocation system
501 Resource allocation unit
502 Resource provision unit
503 Surplus resource amount acquisition unit
504 Parameter determination unit
505 Allocation status management unit

1. A resource allocation system comprising:
a resource allocation unit which allocates resources for executing services, allocating same to one or more functional units providing a predetermined function as a service;
two or more resource provision units which provide resources;
a surplus resource amount acquisition unit which acquires a surplus resource amount from a predetermined resource provision unit among the two or more resource provision units; and
a parameter determination unit which, on the basis of the surplus resource amount, determines at least one among allocation timing, allocatable amount, and priority order at allocation, said allocation timing being timing at which resource allocation control is performed in the resource allocation unit and said allocatable amount being a resource amount that can be allocated during one allocation control.

2. The resource allocation system according to claim 1, further comprising an allocation status management unit which manages resource allocation status in the two or more resource provision units,
wherein the parameter determination unit determines the allocation timing, the allocatable amount, and the priority order on the basis of the surplus resource amount and the allocation status.

3. The resource allocation system according to claim 1, further comprising:
an allocation status management unit which manages resource allocation status in the two or more resource provision units; and
a plurality of data centers serving as management units for resources provided by the two or more resource provision units,
wherein the resource allocation unit, the surplus resource amount acquisition unit, the parameter determination unit, and the allocation status management unit are disposed in each of the data centers,
the surplus resource amount acquisition unit acquires a surplus resource amount from a resource provision unit that provides resources to be managed of an own data center,
the allocation status management unit shares a blockchain, to which a block is added via predetermined consensus processing, with an allocation status management unit disposed in another data center, the block containing allocation information on allocation based on a resource allocation request to any one of the plurality of data centers,
the parameter determination unit determines at least one of the allocation timing, the allocatable amount, and the priority order in the own data center on the basis of the surplus resource amount, and requests the consensus processing to the allocation status management unit of the own data center on the basis of the determination, and
the resource allocation unit allocates resources from the resources to be managed on the basis of information recorded in the blockchain of the own data center.

4. The resource allocation system according to claim 1, further comprising:
an allocation status management unit which manages resource allocation status in the two or more resource provision units; and
a plurality of data centers serving as management units for resources provided by the two or more resource provision units,
wherein the resource allocation unit, the surplus resource amount acquisition unit, the parameter determination unit, and the allocation status management unit are disposed in each of the data centers,
the surplus resource amount acquisition unit acquires a surplus resource amount from a resource provision unit that provides resources to be managed of an own data center,
the allocation status management unit shares a blockchain, to which a block is added via predetermined consensus processing, with an allocation status management unit disposed in another data center, the block containing allocation information on allocation based on a resource allocation request to any one of the plurality of data centers,
the parameter determination unit determines at least one of the allocation timing, the allocatable amount, and the priority order in the own data center on the basis of the surplus resource amount and past resource allocation status indicated by the blockchain of the own data center.

5. The resource allocation system according to claim 3,
wherein the resource allocation unit allocates resources from the resources to be managed on the basis of allocation information in the block at timing when a block is newly added to the blockchain of an own data center.

6. The resource allocation system according to claim 3,
wherein the allocation timing is determined by determining a parameter regarding a difficulty level of the consensus processing.

7. The resource allocation system according to claim 3,
wherein the parameter determination unit selects a request to be controlled from received resource allocation requests on the basis of the determination, and requests the consensus processing for a block containing the allocation information based on the selected request.

8. The resource allocation system according to claim 7,
wherein the parameter determination unit selects a request on the basis of the determined allocatable amount, priority of a received resource allocation request, a request amount of a received resource allocation request, or past allocation frequency to each functional unit grasped from information recorded in the blockchain of an own data center.

9. The resource allocation system according to claim 7,
wherein the parameter determination unit determines a parameter regarding a difficulty level of the consensus processing on the basis of priority or amount of a selected request.

10. The resource allocation system according to claim 3,
wherein the allocatable amount is changed in accordance with time required for the consensus processing.

11. A management device disposed in any one of a plurality of data centers, the data centers being provided as management units for resources provided by two or more resource provision units, the resource provision units providing resources to be allocated to one or more functional units providing a predetermined function as a service, the management device comprising:
a resource allocation unit which allocates resources from the resources to be managed of an own data center to the one or more functional units;
a surplus resource amount acquisition unit which acquires a surplus resource amount from a resource provision unit that provides the resources to be managed;
an allocation status management unit which manages resource allocation status in the two or more resource provision units, the allocation status management unit managing the allocation status by sharing a blockchain, to which a block is added via predetermined consensus processing, with an allocation status management unit disposed in another data center, the block containing allocation information on allocation based on a resource allocation request to any one of the data centers, and
a parameter determination unit which, on the basis of the surplus resource amount, determines at least one among allocation timing, allocatable amount, and priority order at allocation, said allocation timing being timing at which resource allocation control is performed in the resource allocation unit and said allocatable amount being a resource amount that can be allocated during one allocation control,
wherein the resource allocation unit allocates resources on the basis of information recorded in the blockchain as a result of the consensus processing performed on the basis of determination of the parameter determination unit.

12. A method of allocating resources,
wherein an information processing device:
acquires a surplus resource amount from a predetermined resource provision unit among two or more resource provision units which provide resources to be allocated to one or more functional units, the one or more functional units providing a predetermined function as a service; and
determines, on the basis of the surplus resource amount, at least one among allocation timing, allocatable amount, and priority order at allocation, said allocation timing being timing at which resource allocation control is performed in the resource allocation unit and said allocatable amount being a resource amount that can be allocated during one allocation control.

13. (canceled)

14. The resource allocation system according to claim 4,
wherein the resource allocation unit allocates resources from the resources to be managed on the basis of allocation information in the block at timing when a block is newly added to the blockchain of an own data center.

15. The resource allocation system according to claim 4,
wherein the allocation timing is determined by determining a parameter regarding a difficulty level of the consensus processing.

16. The resource allocation system according to claim 5,
wherein the allocation timing is determined by determining a parameter regarding a difficulty level of the consensus processing.

17. The resource allocation system according to claim 14,
wherein the allocation timing is determined by determining a parameter regarding a difficulty level of the consensus processing.

18. The resource allocation system according to claim 4,
wherein the parameter determination unit selects a request to be controlled from received resource allocation requests on the basis of the determination, and requests the consensus processing for a block containing the allocation information based on the selected request.

19. The resource allocation system according to claim 5,
wherein the parameter determination unit selects a request to be controlled from received resource allocation requests on the basis of the determination, and requests the consensus processing for a block containing the allocation information based on the selected request.

20. The resource allocation system according to claim 6,
wherein the parameter determination unit selects a request to be controlled from received resource allocation requests on the basis of the determination, and requests the consensus processing for a block containing the allocation information based on the selected request.

21. The resource allocation system according to claim 14,
wherein the parameter determination unit selects a request to be controlled from received resource allocation requests on the basis of the determination, and requests the consensus processing for a block containing the allocation information based on the selected request.
